(19) United States
(12) Patent Application Publication
(10) Pub. No.: US 2009/0231238 A1
(43) Pub. Date: Sep. 17, 2009

(54) Plasma display device

(75) Inventors: Hirotsugu Fusayasu, Kyoto (JP); Shouichi Mimura, Osaka (JP); Hiroshi Kunimoto, Osaka (JP); Kei Ichikawa, Osaka (JP); Masafumi Kumoi, Osaka (JP); Ryo Matsubara, Osaka (JP); Masato Tobinaga, Hyogo (JP); Toshiyuki Nakaie, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/404,383

(22) Filed: Mar. 16, 2009

(30) Foreign Application Priority Data
Mar. 17, 2008 (JP) 2008-067508
Mar. 17, 2008 (JP) 2008-067509

(51) Int. Cl. G09G 3/28

(52) U.S. Cl. 345/67

(57) ABSTRACT

A plasma display device includes a plasma display module having a plasma display panel provided with a plurality of parallel electrodes, a circuit board for applying a voltage to the electrodes, and a chassis conductor configured to hold the plasma display panel and to which a ground of a circuit board is coupled, and further includes a cylindrical conductor portion configured to surround the plasma display module.

### BACKGROUND OF THE INVENTION

1. Technical Field

The technical field relates to a plasma display device that is known as a thin large-screen display device.

2. Background

Spontaneous light-emitting type display devices such as a plasma display device and a CRT display (Cathode-Ray Tube display) device are widely used since they do not have a viewing angle dependency and can display natural images. In particular, a plasma display device is thin and suitable for forming a large screen, and therefore it is becoming increasingly popular.

A plasma display device mainly includes a plasma display module section having a plasma display panel and a shield case surrounding the module section.

This plasma display panel excites a phosphor provided in each discharge cell by an ultraviolet ray generated by gas discharge so as to emit visible light as display light. The plasma display panel includes a plurality of pairs of scan electrodes and sustain electrodes and a plurality of address electrodes, which are arranged in a lattice. The plasma display panel forms an image by emitting light selectively in a discharge cell that is an intersection portion of the electrodes. With this principle, since large driving current flows in electrodes, an electromagnetic field is generated from a plasma display module due to this current.

Therefore, the plasma display device has a configuration in which a shield case for shielding a generated electromagnetic field is formed, for example, by coupling a front glass to which a conductive filter is attached and a conductive back cover of the rear surface side to each other by using a conductive member to surround a plasma display module. With such a configuration, a generated electromagnetic field is electromagnetically shielded.

However, with the increase in a driving electric power according to the recent improvement of the image quality, it has been difficult to reliably reduce an electromagnetic field by a conventional configuration of a shield case. In particular, in low frequency regions of several tens MHz or less, such an electromagnetic field cannot be sufficiently reduced by a conventional shield case and may be radiated to the outside as a noise.

In order to solve such a problem, Japanese Patent Unexamined Publication No. 2001-83909 discloses a configuration in which an adjacent conductive cylinder is provided on a ground-return conductor plate for connecting between a driving substrate provided at one end of the plasma display device and a driving substrate provided at the other end of the plasma display device. Thus, a plasma display device has been proposed to cancel the inductance of the ground-return conductive plate by an eddy current generated in this adjacent conductive cylinder.

Furthermore, Japanese Patent Unexamined Publication No. 2002-372917 proposes a plasma display device whose shielding performance is enhanced by doubling an electromagnetic shield in a front cabinet by holding and sandwiching a peripheral portion of a front glass of the plasma display device together with a pressing metal.

Furthermore, Japanese Patent Unexamined Publication No. 2005-221797 proposes a plasma display device in which a closed electric current path between a driving source and a load circuit forms at least two loop-structured circuits, so that the magnetic field generated in each loop-structured circuit is cancelled by each other.

Furthermore, Japanese Patent Unexamined Publication No. H10-282896 proposes a plasma display device having a configuration in which a chassis conductor holding a plasma display panel is coupled to a back cover and surrounds a drive circuit board to form a shield.

However, in the plasma display device described in Japanese Patent Unexamined Publication No. 2001-83909, when the adjacent conductive cylinder having a size that can be expected to have a reducing effect is inserted inside the plasma display panel and the ground-return conductor plate, an entire area of the loop of an electric current that is a generating source of an electromagnetic field is enlarged. As a result, electromagnetic fields to be reduced are increased, thus deteriorating the effect of reducing electromagnetic fields.

Furthermore, in the plasma display device described in Japanese Patent Unexamined Publication No. 2002-372917, the front cabinet having double electromagnetic shield is positioned only in a side surface portion of the entire device. Therefore, the effect by the double shield is limited only to this portion. Consequently although the shielding effect is improved, the effect is not sufficient from the viewpoint of reducing an electromagnetic field caused by a driving current.

Furthermore, in the plasma display device described in Japanese Patent Unexamined Publication No. 2005-221797, since a driving current path itself is extended, it is necessary to adjust a drive signal waveform and the like. Furthermore, since it is difficult to completely cancel electromagnetic fields generated in the two loop structures, it is difficult to achieve a sufficient reducing effect.

Furthermore, in the plasma display device described in Japanese Patent Unexamined Publication No. H10-282896, the shielding effect of the drive circuit board itself is increased. However, an electromagnetic field generated by an electric current flowing between the plasma display panel and the chassis conductor cannot be reduced sufficiently.

### SUMMARY

A plasma display device of the present invention includes a plasma display module and a cylindrical conductor portion.

The plasma display module includes a front glass plate and a rear glass plate provided with a plurality of electrodes that are in parallel to each other, a plasma display panel having a plurality of discharge cells divided by barrier ribs, a circuit board for applying a voltage to an electrode, and a chassis conductor configured to hold a plasma display panel and to which ground of a circuit board is coupled.

The cylindrical conductor configured to surround a plasma display module by a first conductor portion located at the front surface side of the plasma display module, and a second conductor portion located at the pair of the side surface and at a rear surface which a plasma display module faces.

A loop formed by the cylindrical conductor is substantially in parallel to a loop formed by a current flowing in a circuit board, an electrode and a chassis conductor in a plasma display module.

With such a configuration, by a cancelling effect by the cylindrical conductor, it is possible to provide a plasma display device capable of efficiently reducing an interfering electromagnetic wave caused by a driving current flowing a plasma display panel.

### BRIEF DESCRIPTION OF THE DRAWINGS

FIG. 1 is a schematic cross-sectional view showing a configuration of a plasma display device in accordance with a first embodiment of the present invention.

FIG. 2 is a schematic longitudinal sectional view showing a plasma display device in accordance with the first embodiment of the present invention.

FIG. 3 is a perspective view to illustrate a configuration of the plasma display module.

FIG. 4A is a perspective view to illustrate an electrode structure of the plasma display panel in a plasma display device in accordance with the first embodiment.

FIG. 4B is a sectional view to illustrate an electrode structure of the plasma display panel in a plasma display device in accordance with the first embodiment.

FIG. 5 is a perspective view to illustrate a structure of a conductive front filter of a plasma display panel in the plasma display device in accordance with the first embodiment.

FIG. 6 is a conceptual view to illustrate a principle in which undesirable radiation of an interfering electromagnetic wave occurs due to a panel driving current by a plasma display panel in the plasma display device in accordance with the first embodiment.

FIG. 7A is a perspective view to illustrate a position relation between an electrode structure of the plasma display panel and a first conductive filter in accordance with the second embodiment.

FIG. 7B is a sectional view to illustrate a position relation between an electrode structure of the plasma display panel and a first conductive filter in accordance with the second embodiment.

FIG. 8 is a schematic cross-sectional view to illustrate a configuration of a plasma display device in accordance with a third embodiment of the present invention.

FIG. 9 is a schematic cross-sectional view to illustrate a configuration of a plasma display device in accordance with a fourth embodiment of the present invention.

FIG. 10 is a schematic cross-sectional view to illustrate a configuration of another example of a plasma display device in accordance with a fourth embodiment of the present invention.

FIG. 11A is a schematic cross-sectional view to illustrate a configuration of a plasma display device in accordance with a fifth embodiment of the present invention.

FIG. 11B is a partial enlarged view showing a back cover of the plasma display device in accordance with a fifth embodiment of the present invention.

FIG. 12 is a schematic cross-sectional view to illustrate a configuration of a plasma display device in accordance with a sixth embodiment of the present invention.

FIG. 13A is a perspective view to illustrate a structure of electrodes of a plasma display panel of a plasma display device in accordance with the sixth embodiment of the present invention.

FIG. 13B is a sectional view to illustrate a structure of electrodes of a plasma display panel of a plasma display device in accordance with the sixth embodiment of the present invention.

FIG. 14 is a sectional view showing a plasma display panel in a plasma display device in accordance with a seventh embodiment.

FIG. 15 is a sectional view showing a plasma display panel in a plasma display panel of a plasma display device in accordance with an eighth embodiment.

FIG. 16 is a schematic cross-sectional view to illustrate a configuration of a plasma display device in accordance with a ninth embodiment of the present invention.

FIG. 17A is a schematic cross-sectional view to illustrate a configuration of a plasma display device in accordance with a tenth embodiment of the present invention.

FIG. 17B is a partial enlarged view showing a back cover of a plasma display device in accordance with the tenth embodiment of the present invention.

### DETAILED DESCRIPTION OF PREFERRED EMBODIMENTS

Hereinafter, embodiments of the present invention are described with reference to drawings. Note here that the same reference numerals are given to the same elements carrying out the same operations in the embodiments.

### First Embodiment

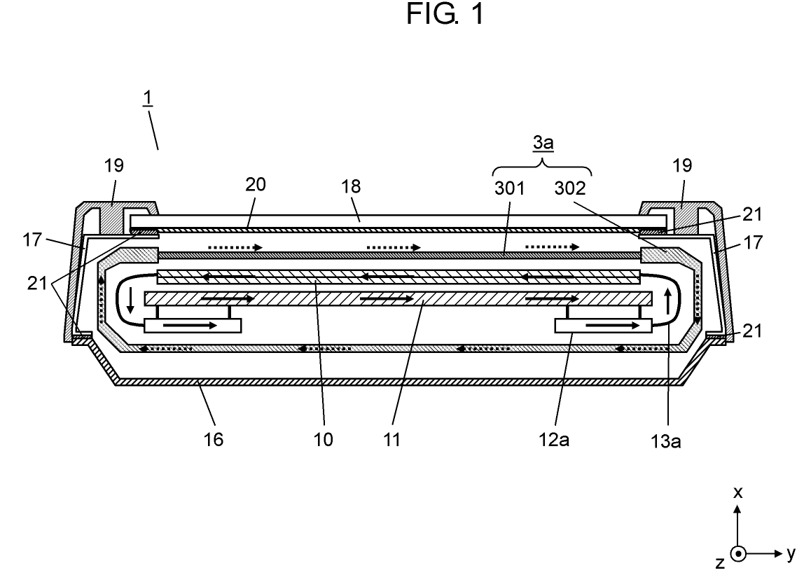

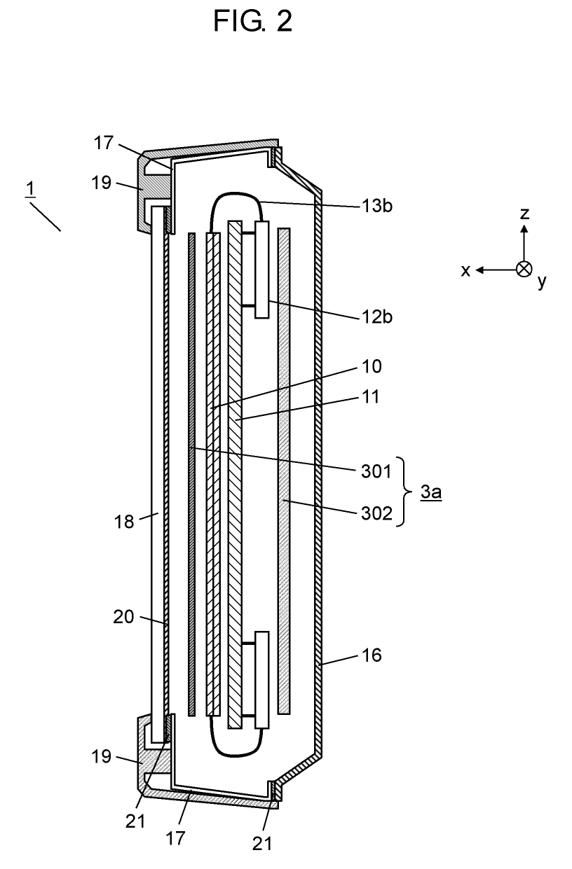

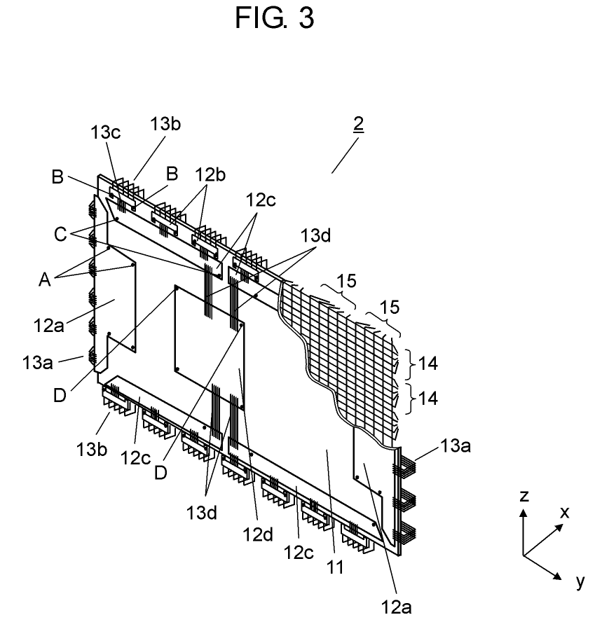

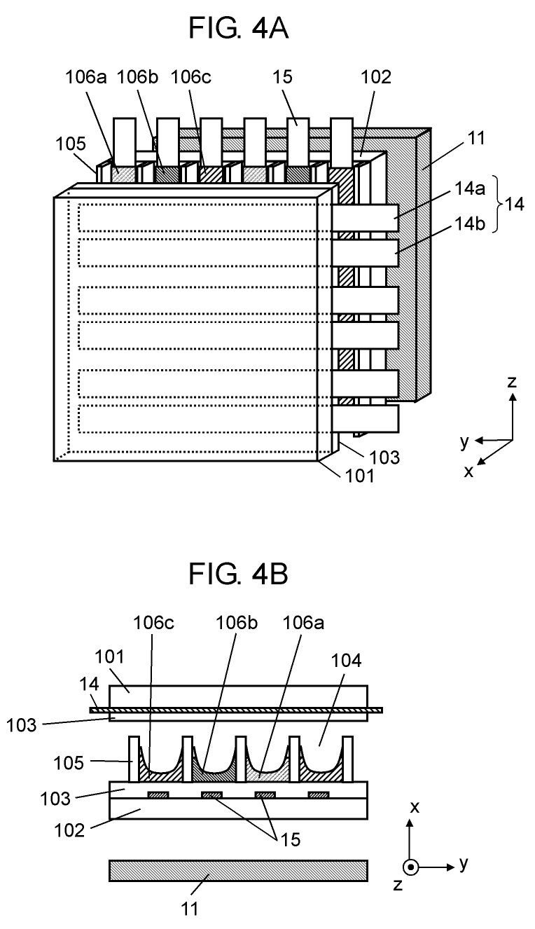

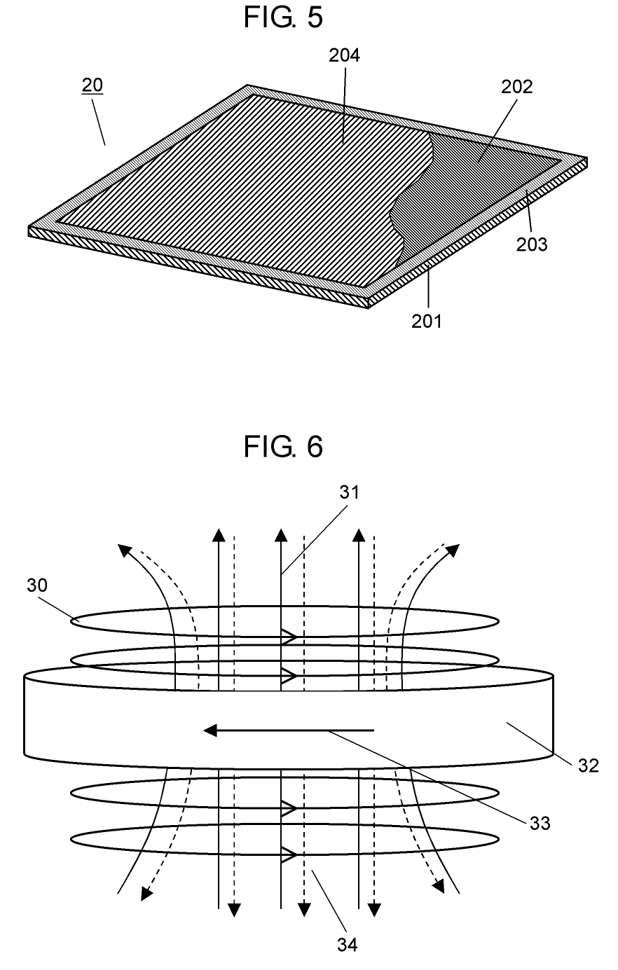

FIGS. 1 to 4A and 4B show plasma display device 1 in accordance with a first embodiment. FIG. 1 is a schematic cross-sectional view taken along the x-y plane to illustrate a configuration of plasma display device 1 in accordance with the first embodiment of the present invention. FIG. 2 is a schematic longitudinal sectional view taken along the x-z plane. Note here that FIGS. 1 and 2 show only a structure that deeply relates to radiation of undesirable electromagnetic wave in the first embodiment. FIG. 3 is a perspective view to illustrate a configuration of plasma display module 2. FIG. 4A is a perspective view to illustrate a structure of electrodes of plasma display panel 10 in plasma display device 1 in accordance with the first embodiment. FIG. 4B is a sectional view thereof. FIG. 5 is a perspective view to illustrate a structure of conductive front filter 20.

Hereinafter, for the sake of convenience, a normal direction of a display surface of plasma display device 1 is referred to as an x-axis, a longitudinal direction of a display surface of plasma display device 1 is referred to as a y-axis, and a direction orthogonal to the x-axis and y-axis is referred to as a z-axis.

In FIGS. 1-3, plasma display module 2 of plasma display device 1 in accordance with the first embodiment of the present invention includes plasma display panel 10 having a plurality of scan-sustain electrodes 14 that are electrodes parallel to each other in the longitudinal direction and address electrodes 15 that are parallel to each other in the short direction. In plasma display module 2, chassis conductor 11 that is a holder plate of plasma display panel 10 is disposed at the opposite side to the display surface of plasma display panel 10 via a thermal conductive sheet (not shown).

Firstly a configuration for driving scan-sustain electrodes 14 and address electrode 15 is described. Scan-sustain electrodes drive circuit board 12a, address electrode drive circuit board 12b, junction circuit board 12c, and discharge control circuit board 12d, which function as circuit boards for applying a voltage to electrodes, are disposed at the rear side of chassis conductor 11. A drive signal generated from scan-sustain electrodes drive circuit board 12a for driving scan-sustain electrodes 14 is transmitted to scan-sustain electrodes 14 of plasma display panel 10 by flexible cable 13a. In order to drive address electrode 15, firstly, a high frequency signal generated at discharge control circuit board 12d is transmitted to junction circuit board 12c by flexible cable 13d. Next, the high frequency signal is transmitted to address electrode drive circuit board 12b by flexible cable 13c. Then, a drive signal is generated in address electrode drive circuit board 12b and transmitted to address electrode 15 of plasma display panel 10 by flexible cable 13b.

At the outside of plasma display module 2, cylindrical conductor portion 3a is provided in a way in which it surrounds and encloses plasma display module 2. Cylindrical conductor portion 3a includes conductive filter 301 as a first conductor portion and second conductor portion 302. At the outside of cylindrical conductor portion 3a, back cover 16, glass pressing metal 17, front protective glass 18, front cabinet 19, conductive front filter 20 and conductive gasket 21 form a shield case.

Plasma display panel 10 has a structure in which front glass plate 101 and rear glass plate 102 are attached to each other as shown in FIGS. 4A and 4B. On front glass plate 101, dielectric layer 103 is formed. A large number of scan-sustain electrodes 14 each consisting of a scan electrode 14a and sustain electrode 14b are formed in a way in which they are protected by dielectric layer 103. Dielectric layer 103 is formed also on rear glass plate 102. A large number of address electrodes 15 are formed in a way in which they are protected by dielectric layer 103.

A portion that is a crossing position of scan-sustain electrodes 14 and address electrode 15 and that is surrounded by scan-sustain electrodes 14 and address electrode 15 is discharge cell 104. Discharge cell 104 is filled with a discharge gas including a noble gas such as helium (He), neon (Ne) and xenon (Xe). Discharge cells 104 are divided by barrier ribs 105 and the inside of each discharge cell 104 is differently colored by red, blue and green phosphors 106a to 106c.

Chassis conductor 11 is made of a plate of metal such as aluminum and copper having high thermal conductivity and electrical conductivity. Plasma display panel 10 is attached to one surface (front surface) of chassis conductor 11 via a thermal conductive sheet. Furthermore, drive circuit boards and the like is attached to the other surface (rear surface) of chassis conductor 11 in parallel to chassis conductor 11 and coupled to ground of each circuit board. Therefore, chassis conductor 11 holds plasma display panel 10 and drive circuit boards and the like, and functions as a reinforcing material for maintaining the strength thereof. Furthermore, chassis conductor 11 also functions as an electric ground of each drive circuit board. As shown in FIG. 3, for example, a signal ground of scan-sustain electrodes drive circuit board 12a is point A, a signal ground of address electrode drive circuit board 12b is point B, a signal ground of junction circuit board 12c is point C, and a signal ground of discharge control circuit board 12d is point D. Then, each signal ground is grounded on chassis conductor 11 that is a frame ground, respectively.

Conductive front filter 20 includes base layer 201, conductive layer 202, metal end portion 203 and protective film 204 as shown in FIG. 5. Base layer 201 is made of, for example, polyester film. Conductive layer 202 is formed on base layer 201 by metal mesh formation or sputter formation. Metal end portion 203 is formed on the peripheral portion of conductive layer 202. Protective film 204 is formed of a transparent insulating resin on conductive layer 202. Since metal end portion 203 is not covered with protective film 204, it functions as an electric connection portion.

Note here that conductive layer 202 uses metal mesh such as copper mesh and sputter formation such as silver sputtering. When the metal mesh is used, a higher shielding effect can be obtained because the resistance rate is low. When the sputter formation is used, construction can be carried out at a lower cost.

As shown in FIGS. 1 and 2, front protective glass 18 is disposed at the front surface side of plasma display panel 10. Conductive front filter 20 is attached to the rear surface of front protective glass 18, that is, at the side opposite to the display surface.

Glass pressing metal 17 fixes front protective glass 18 by holding it between glass pressing metal 17 and front cabinet 19. Furthermore, glass pressing metal 17 is disposed in a way in which it is brought into electrical contact with metal end portion 203 of conductive front filter 20 attached to front protective glass 18 via conductive gasket 21 that is a conductive contacting member. Furthermore, glass pressing metal 17 is also brought into contact with back cover 16 via conductive gasket 21.

Note here that the conductive gasket is made by, for example, attaching metal fiber to an elastic material like a sponge. Herein, as a conductive contacting member, a conductive gasket is used but the member is not necessarily limited to this. That is to say, any members having an electrical conductivity and securing stability in electrical contact between two members may be used. For example, glass pressing metal 17 may be provided with a conductive spring portion. Thus, the cost can be lowered.

Back cover 16 is formed by press molding a conductive metal plate. Back cover 16 is fixed to glass pressing metal 17 so as to cover the rear surface of plasma display panel 10 and drive circuit boards, and the like. It plays a role of shielding an electromagnetic wave radiated from plasma display panel 10, each drive circuit board, and the like.

Cylindrical conductor portion 3a includes a conductor portion consisting of conductive filter 301 that is a first conductor portion located at the front surface side of plasma display panel 10 and second conductor portion 302 located at a pair of side-surfaces facing each other (right and left side-surfaces in this embodiment) and the rear surface side of plasma display module 2. Conductive filter 301 and second conductor portion 302 are electrically coupled to each other so as to form a loop. The role of the formed loop is detailed below in detail.

Conductive filter 301 is a flat-shaped filter having a light transmission property and an example of the first conductor portion. That is to say, the first conductor portion is configured to face the image display surface of plasma display panel 10, and includes conductive filter 301 as a first conductive filter having a light transmission property and a substantially rectangular surface. Furthermore, second conductor portion 302 has a substantially rectangular U-letter cross section coupled to two facing sides of conductive filter 301. That is to say, cylindrical conductor portion 3a has a substantially cylindrical shape having an opening on the upper and lower side surfaces of plasma display module 2 and configures to surround plasma display module 2.

Conductive filter 301 has the same configuration as that of conductive front filter 20. Furthermore, second conductor portion 302 is formed of metal having high electrical conductivity, for example, aluminum, copper, and the like.

When conductive front filter 20 is formed of a metal mesh, it is preferable that conductive filter 301 has a conductive layer formed by sputtering. This is preferable because if two metal mesh films are laminated onto each other, an interference fringe may be observed when they are seen from the display surface, thus deteriorating an image quality.

In the above-mentioned configuration, as shown in FIG. 1, a loop shown by a dotted-line arrow is a loop formed by a conductor portion of cylindrical conductor portion 3a. On the other hand, a loop shown by a solid-line arrow is a loop formed by a driving current in plasma display module 2. That is to say, the loop formed by a conductor portion of cylindrical conductor portion 3a is substantially in parallel to the loop formed by a current flowing in scan-sustain electrodes drive circuit board 12a, scan-sustain electrodes 14 as an electrode and chassis conductor 11 in plasma display module 2 (substantially parallel to the x-y plane).

Herein, in plasma display device 1 in accordance with this embodiment, the principle and operation in which undesirable radiation of interfering electromagnetic wave due to the driving current is reduced are described based on the operation principle of a plasma display panel.

Firstly the image display principle of plasma display panel 10 is described. Firstly, a voltage is applied to all lines of scan electrode 14a so as to carry out initializing discharge causing discharge in all discharge cells 104. Next, a voltage is sequentially applied to scan electrode 14a and a voltage is also applied to address electrode 15 that intersects with discharge cell 104 to emit light on scan electrode 14a to which a voltage is applied. This is called address discharge, and discharge cell 104 in a position where scan electrode 14a to which a voltage is applied and address electrode 15 intersect with each other emits light and discharge cell 104 is selected as a light emission cell. Thereafter, sustain discharge in which an AC voltage is applied between scan electrode 14a and sustain electrode 14b is carried out. By sustain discharge, only a previously selected light emitting cell emits light, and a plasma display panel displays an image. That is to say an electrode is scan electrode 14a and sustain electrode 14b, and scan-sustain electrodes 14 that are elements constituting discharge cell 104.

Next, the principle and operation in which undesirable radiation of interfering electromagnetic waves due to a driving current is reduced is described with reference to FIG. 6. FIG. 6 is a conceptual view to illustrate a principle in which undesirable radiation of interfering electromagnetic waves due to a panel driving current is reduced.

In general, when loop current 30 flows, strong generated magnetic field 31 is generated in the direction perpendicular to a plane forming a loop by Ampere's right handed screw rule. When ring-shaped conductor 32 is placed in a position encompassing loop current 30, a counter electromotive force is generated on this conductor due to the electromagnetic induction effect. At this time, induced current 33 is induced in ring-shaped conductor 32 in the direction opposite to the original loop current 30. This ring-shaped conductor 32 is referred to as a short ring. This induced generated magnetic field 34 by induced current 33 is generated in the reverse direction with respect to generated magnetic field 31 by loop current 30. Therefore, generated magnetic field 34 has an effect of cancelling original generated magnetic field 31.

In the configuration of FIG. 1, a driving current driven by scan-sustain electrodes drive circuit board 12a flows in flexible cable 13a, scan-sustain electrodes 14 of plasma display panel 10 and chassis conductor 11 so as to form a loop-shaped driving current.

Furthermore, the loop-shaped driving current generates a magnetic field in the vertical direction by the right screw rule. Note here that the vertical direction means a direction parallel to the z-direction in FIG. 1.

Herein, the loop formed by cylindrical conductor portion 3a is substantially in parallel to the loop of the driving current in plasma display module 2. Therefore, according to the above-mentioned principle, a loop current in the reverse direction with respect to the driving current is excited in cylindrical conductor portion 3a so as to cancel the magnetic field generated from plasma display module 2.

Thus, with respect to an alternative magnetic field formed by a loop of a driving current generated at the time of sustain discharge when a particularly large current flows, cylindrical conductor portion 3a plays a role of a short ring. Thus, an effect of cancelling a magnetic field can be achieved, and as a result, a large effect of reducing a noise can be achieved.

In this embodiment, second conductor portion 302 of cylindrical conductor portion 3a has substantially rectangular U-shaped cross section. However, the shape is not limited to this alone. In short, it may have a configuration in which a current flows in the reverse direction with respect to the driving current loop. For example, both ends of conductive filter 301 may be bent in the direction toward back cover 16 so as to be brought into contact with a flat plane shaped second conductor portion 302. This can simplify the structure of second conductor portion 302.

### Second Embodiment

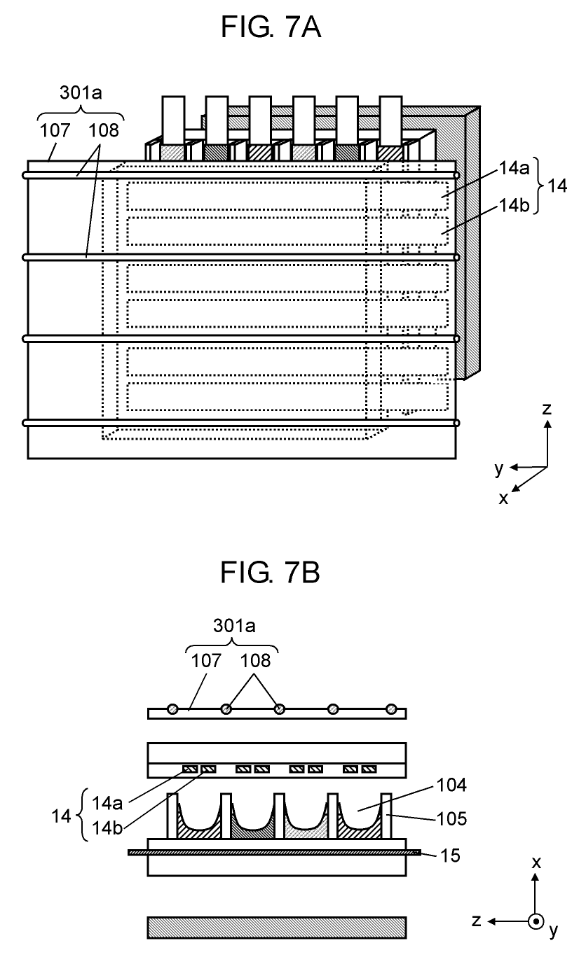

Next, a second embodiment of the present invention is described with reference to FIGS. 7A and 7B. The same reference numerals are given to the same configuration as in the first embodiment and detailed description thereof is omitted. In the first embodiment, as conductive filter 301 that is the first conductor portion, a flat-shaped filter having a light transmission property is used. However, the second embodiment is different from the first embodiment in that the first conductor portion is conductive filter 301a having metal thin wires 108 located above barrier ribs between discharge cells 104 seen from a viewer.

FIG. 7A is a perspective view to illustrate the position relation between an electrode structure of plasma display panel 10 and conductive filter 301a in accordance with the second embodiment. FIG. 7B is a sectional view thereof.

Conductive filter 301a as the first conductive filter includes base material 107 made of resin and a plurality of metal thin wires 108 arranged in parallel to scan-sustain electrodes 14 as electrodes on base material 107. Metal thin wires 108 are disposed in a way in which they are located above the front surface of barrier ribs 105 seen from the side of a viewer, that is, the side opposite to back cover 16 so as not to block the side of the display surface of discharge cell 104. That is to say, metal thin wires 108 are disposed in a way in which they are located above the barrier ribs 105 between discharge cells 104 of plasma display panel 10. Therefore, it is possible to use metal thin wire 108 that is thicker as compared with the case where a general metal mesh filter is used.

With such a configuration, an electric resistance of conductive filter 301a can be made smaller as compared with the case where a metal mesh is used. Thus, the electrical conductivity of cylindrical conductor portion 3a is increased and an induced current flows easily. As a result, it becomes possible to achieve a large effect of cancelling a magnetic field. Consequently, it is possible to achieve a large effect of reducing noise.

Furthermore, a plurality of metal thin wires 108 arranged in parallel to scan-sustain electrodes 14 can be formed without substantially blocking the transmittance of image light emitted from discharge cell 104. Thus, hindrance to an image of the plasma display panel can be reduced.

### Third Embodiment

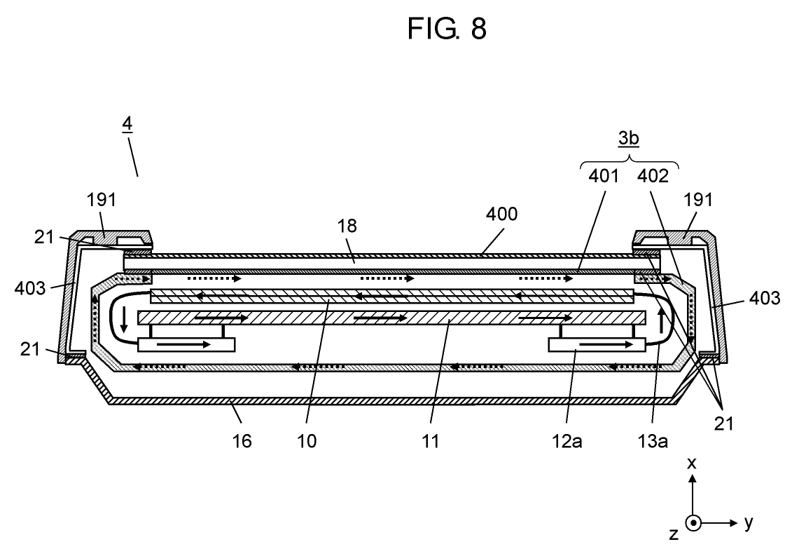

Next, a third embodiment of the present invention is described with reference to FIG. 8. The same reference numerals are given to the same configuration as in the first embodiment and the detailed description thereof is omitted. In the first embodiment, as conductive filter 301 that is the first conductor portion, a flat-shaped filter having a light transmission property is used. However, the third embodiment is different in that the first conductor portion is first conductive filter 401. Note here that second conductor portions 302 and 402 may have the same configuration.

FIG. 8 is a schematic cross-sectional view taken along the x-y plane to illustrate a configuration of plasma display device 4 in accordance with the third embodiment of the present invention.

As shown in FIG. 8, front protective glass 18 has conductive front filter 400 that is a second conductive filter provided at the side facing a display surface. Furthermore, first conductive filter 401 of cylindrical conductor portion 3b is attached to front protective glass 18 at the side opposite to the display surface.

Glass pressing metal 403 is brought into contact with conductive front filter 400 via conductive gasket 21 at the display surface side of the front protective glass 18. Furthermore, first conductive filter 401 and second conductor portion 402 are brought into electrical contact with each other via conductive gasket 21.

With such a configuration, since first conductive filter 401 is attached to the rear surface of front protective glass 18, separate first conductive filter 301 as in the first embodiment shown in FIG. 1 is not needed. Consequently, the thickness of plasma display device 4 can be further reduced.

Note here that first conductive filter 401 and conductive front filter 400 may have the same configuration as that of conductive front filter 20 described in the first embodiment. Therefore, as described above, it is not desirable that both first conductive filter 401 and conductive front filter 400 are formed of a metal mesh. This is because when two metal mesh films are laminated onto each other, an interference fringe may be observed seen from the display surface, thus deteriorating the image quality. It is preferable that both first conductive filter 401 and conductive front filter 400 have a conductive layer formed by sputtering. Furthermore, any one of first conductive filter 401 and conductive front filter 400 may be formed of a metal mesh and the other may be formed so as to have a conductive layer formed by sputtering.

Furthermore, since front protective glass 18 is prepared in a state in which first conductive filter 401 and conductive front filter 400 as the second conductive filter are attached from the beginning, assembly can be simplified as compared with the first embodiment.

As mentioned above, plasma display device 4 in accordance with this embodiment further includes front protective glass 18 provided at the side opposite to back cover 16 of plasma display module 2. The second conductive filter is provided on the surface at the side opposite to back cover 16 of front protective glass 18, and the first conductive filter is provided on the surface of front protective glass 18 at the side facing the plasma display panel 10.

With such a configuration, also in the third embodiment, similar to the first embodiment, an effect of cancelling a magnetic field can be achieved. As a result, a large effect of reducing noise can be achieved.

### Fourth Embodiment

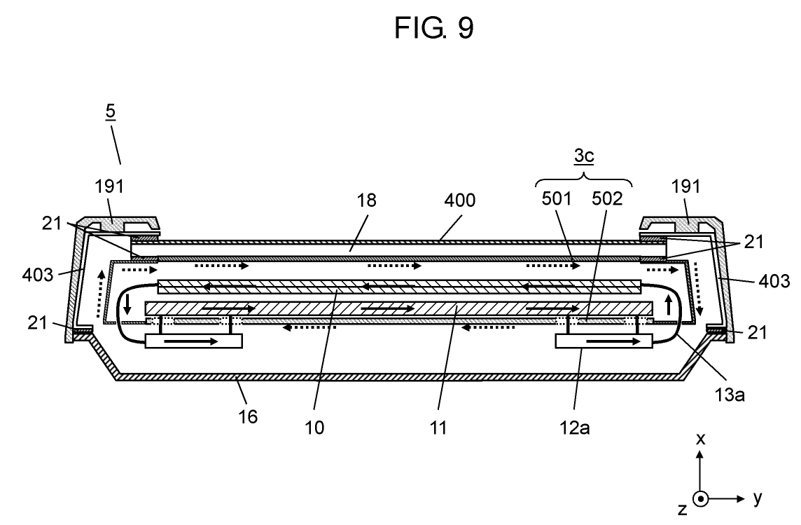

Next, a fourth embodiment of the present invention is described with reference to FIG. 9. The same reference numerals are given to the same configuration as in the third embodiment and the detailed description thereof is omitted. In the third embodiment, second conductor portion 402 is used similar to second conductor portion 302 in the first embodiment. However, the fourth embodiment is different in that second conductor portion 502 is used in cylindrical conductor portion 3c. Note here that first conductive filters 401 and 501 may have the same configuration.

FIG. 9 is a schematic cross-sectional view to illustrate a configuration of plasma display device 5 in accordance with the fourth embodiment of the present invention.

As shown in FIG. 9, plasma display device 5 in accordance with this embodiment includes a conductor layer on chassis conductor 11 via an insulating layer. Grounds of various drive circuit boards are coupled to chassis conductor 11. Furthermore, the conductor layer is disposed on chassis conductor 11 at the side opposite to the plasma display panel. The conductor layer is coupled to first conductive filter 501 as the first conductor portion so as to form second conductor portion 502. That is to say, first conductive filter 501 and second conductor portion 502 as the conductor layer form cylindrical conductor portion 3c.

Furthermore, second conductor portion 502 has a plurality of openings in a part thereof. Flexible cable 13a is coupled to second conductor portion 502 via the opening. Furthermore, grounds of various drive circuit boards are not brought into electrical contact with second conductor portion 502 but coupled to chassis conductor 11.

With such a configuration, since second conductor portion 502 is laminated onto chassis conductor 11, the thickness of plasma display device 5 can be further reduced as compared with the first to third embodiments.

Furthermore, since preparation of disposing a conductor layer on chassis conductor 11 via an insulating layer is carried out in advance, assembly can be further simplified as compared with the first embodiment.

With such a configuration, also in the third embodiment, similar to the first embodiment, an effect of cancelling a magnetic field can be achieved. As a result, a large effect of reducing noise can be achieved.

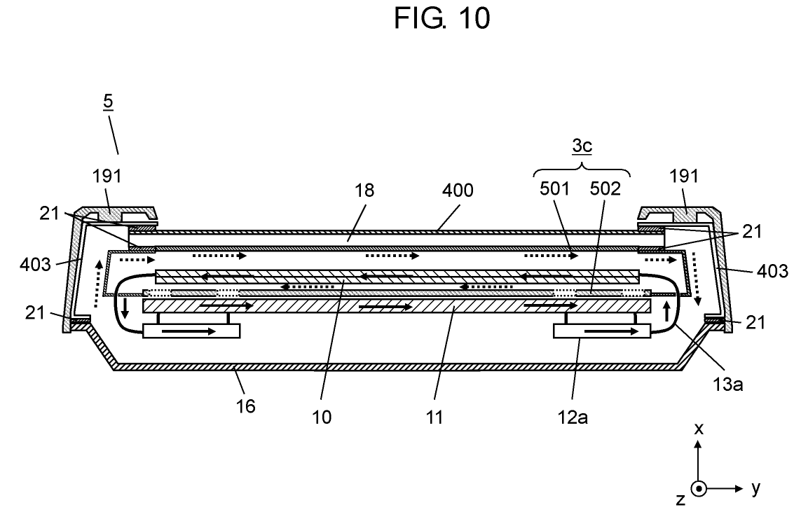

Furthermore, in this embodiment, second conductor portion 502 is disposed on chassis conductor 11 via an insulating layer. Therefore, chassis conductor 11 and second conductor portion 502 have a two-layered structure. Furthermore, grounds of various drive circuit boards are coupled to chassis conductor 11 at the side of plasma display panel 10. However, plasma display device 5 in this embodiment is not necessarily limited to such a configuration. FIG. 10 is a schematic cross-sectional view to illustrate a configuration of another example of plasma display device 5 in accordance with the fourth embodiment of the present invention. That is to say, as shown in FIG. 10, second conductor portion 502 as the conductor layer may be disposed on chassis conductor 11 at the side of plasma display panel 10. Also with such a configuration, an effect of cancelling a magnetic field can be achieved.

As mentioned above, the plasma display device in this embodiment includes a conductor layer disposed on chassis conductor 11 via an insulating layer. Any one of chassis conductor 11 and the conductor layer of the plasma display device may be coupled to grounds of various drive circuit boards and the other may be coupled to the first conductor portion so as to form a second conductor portion. Also in this case, similar to the first embodiment, an effect of cancelling a magnetic field can be achieved, and as a result, a large effect of reducing noise can be achieved.

However, in a configuration in which grounds of various drive circuit boards are coupled to a conductor layer at the side of plasma display panel 10 as in this embodiment, since a loop of a driving current and a loop of cylindrical conductor portion 3c are interlinkaged more widely, the effect of reducing noise is increased.

### Fifth Embodiment

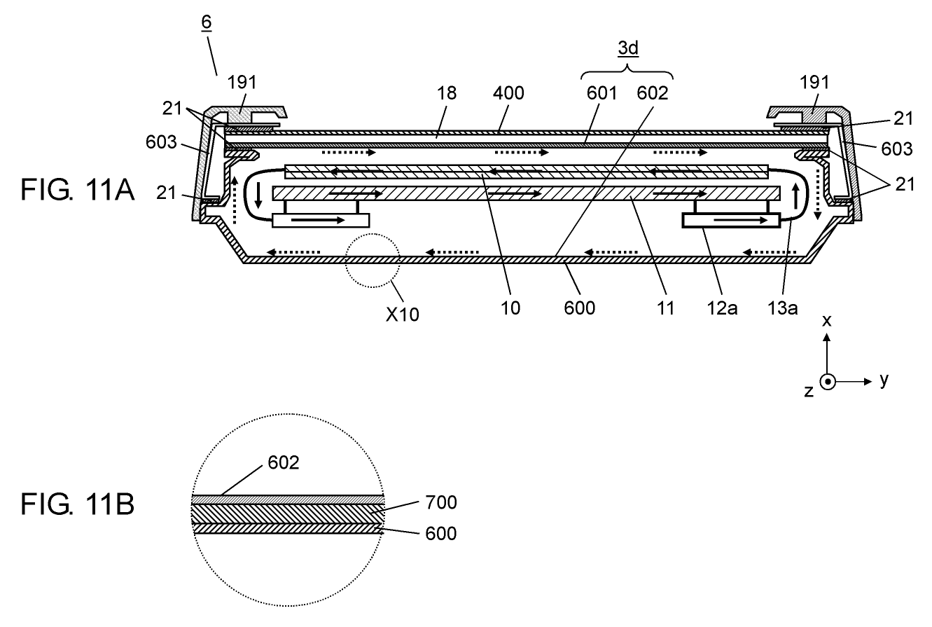

Next, a fifth embodiment of the present invention is described with reference to FIGS. 11A and 11B. The same reference numerals are given to the same configuration as in the third embodiment and the detailed description thereof is omitted. In the third embodiment, second conductor portion 402 of cylindrical conductor portion 3b is used to form cylindrical conductor portion 3b. The fifth embodiment is different in that second conductor portion 602 formed on back cover 600 is used so as to form cylindrical conductor portion 3d. Note here that first conductive filters 401 and 601 may have the same configuration.

FIG. 11A is a schematic cross-sectional view to illustrate a configuration of plasma display device 6 in accordance with the fifth embodiment of the present invention. FIG. 11B is an expanded view showing a region X10 in FIG. 11A.

As shown in FIG. 11B, in back cover 600 functioning as a conductive case, second conductor portion 602 of cylindrical conductor portion 3d is formed on the inner side of conductive back cover 600 via insulating layer 700 by conductive plating. Furthermore, as shown in FIG. 11A, back cover 600 is electrically coupled to glass pressing metal 603 at the outer side surface via conductive gasket 21. Furthermore, second conductor portion 602, which is formed on the inner side by plating, of back cover 600 is brought into electrical contact with first conductive filter 601 via conductive gasket 21.

At this time, the inside and outside of back cover 600 are electrically insulated from each other, and cylindrical conductor portion 3d is not electrically connected to back cover 600 or glass pressing metal 603, which functions as a short ring function.

As mentioned above, plasma display device 6 in this embodiment has back cover 600 as a conductive case at the side opposite to a viewer of a plasma display module, that is, at the side opposite to the display surface. An insulating layer is formed on the inner side of the conductive case. Second conductor portion 602 is formed on an insulating layer of the conductive case by conductive plating.

With such a configuration, since second conductor portion 602 is formed on the inner side of back cover 600 by plating, separate second conductor portions 302 and 402 as in the first to third embodiments are not needed. Furthermore, since a two-layered structure of chassis conductor 11 and second conductor portion 502 as in the fourth embodiment is not also needed, the thickness of plasma display device 6 can be further reduced.

Furthermore, since preparation of subjecting back cover 600 to insulation treatment and plating treatment can be carried out in advance, assembly can be simplified as compared with the first to third embodiments.

Note here that the formation of second conductor portion 602 is not necessarily limited to plating. For example, the formation may be carried out by attaching with the use of, for example, a metal tape.

Also in this embodiment, similar to the first embodiment, an effect of cancelling a magnetic field can be achieved. As a result, a large effect of reducing noise can be achieved.

### Sixth Embodiment

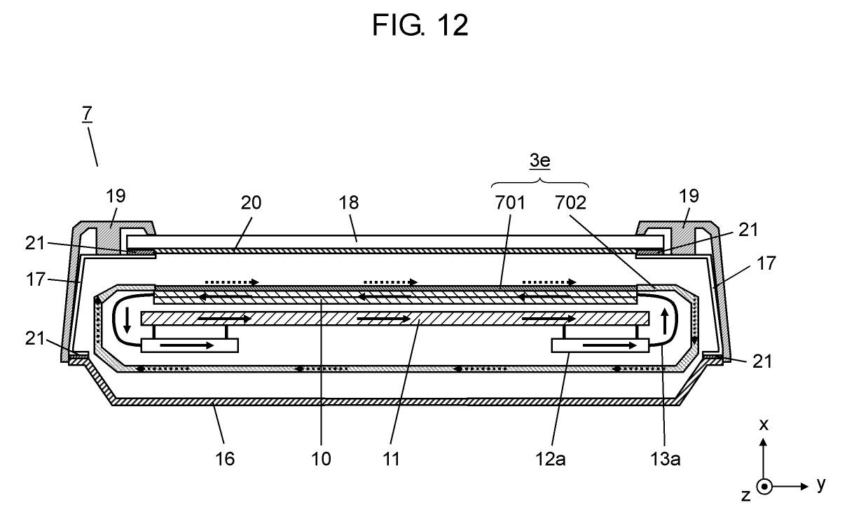

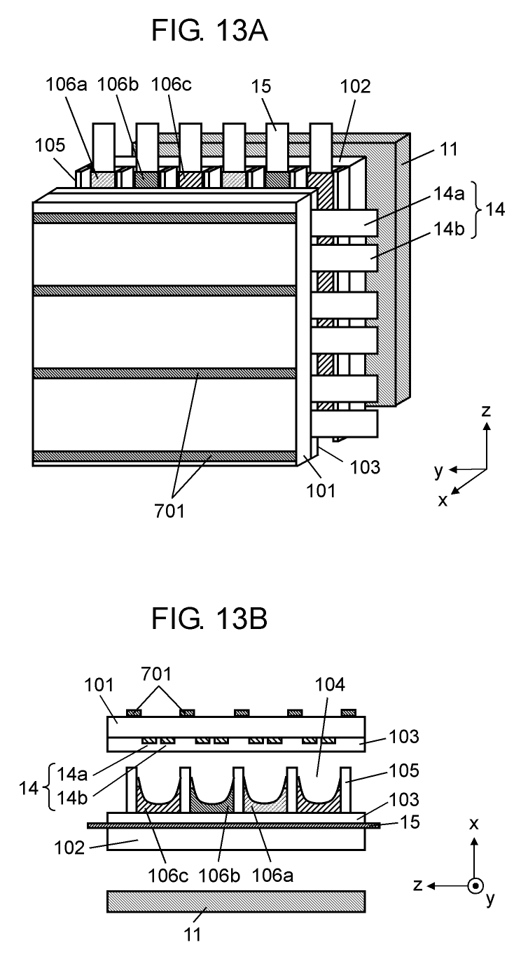

Next, a sixth embodiment of the present invention is described with reference to FIG. 12 and FIGS. 13A and 13B. The same reference numerals are given to the same configuration as in the first embodiment and the detailed description thereof is omitted. In the first embodiment, as conductive filter 301 that is a first conductor portion in cylindrical conductor portion 3a, a flat-shaped filter having a light transmission property is used. However, the sixth embodiment is different in that conductor wiring portion 701 is used as the first conductor portion. Note here that second conductor portions 302 and 702 may have the same configuration.

FIG. 12 is a schematic cross-sectional view to illustrate a configuration of plasma display device 7 in accordance with the sixth embodiment, which shows only a structure deeply relating to the radiation of undesirable electromagnetic wave as the embodiment. FIG. 13A is a perspective view to illustrate an electrode structure of plasma display panel 10 in plasma display device 7 in accordance with the sixth embodiment. FIG. 13B is a sectional view of FIG. 13A.

In FIG. 12, cylindrical conductor portion 3e includes conductor wiring portion 701 as a first conductor portion formed on the display surface side of front glass plate 101 in plasma display panel 10, that is, at the side opposite to back cover 16, and second conductor portion 702 coupled to both ends of conductor wiring portion 701 and having substantially a rectangular U-shaped cross section. Cylindrical conductor portion 3e encloses plasma display module 2.

As shown in FIGS. 13A and 13B, conductor wiring portion 701 includes a plurality of metal wirings provided on the front surface side of front glass plate 101 of plasma display panel 10. Conductor wiring portion 701 is formed by etching a metal material such as copper on front glass plate 101. Furthermore, second conductor portion 702 is formed of a metal such as aluminum and copper having a high electrical conductivity.

With such a configuration, since conductor wiring portion 701 is attached to the surface of front glass plate 101 of plasma display panel 10, a separate first conductor portion as in the first embodiment of FIG. 1 is not needed. Consequently, the thickness of plasma display device 7 can be further reduced as compared with the first embodiment.

Furthermore, since plasma display panel 10 can be prepared in a state in which conductor wiring portion 701 is attached from the beginning, assembly can be simplified as compared with the first embodiment.

Furthermore, a plurality of metal wirings arranged in parallel to scan-sustain electrodes 14 are disposed in a way in which they are located above the front surface of barrier ribs 105 between discharge cells 104 seen from the side of a viewer, that is, the side opposite to back cover 16 so as not to block the side of the display surface of discharge cell 104. That is to say, a plurality of metal wirings of conductor wiring portion 701 are disposed in a way in which they are located above barrier ribs 105 between discharge cells 104 of plasma display panels 10. Thus, they can be formed in the position that is closer to barrier ribs 105 as compared with the second embodiment. Thus, they can be formed without substantially blocking the transmittance of image light emitted from discharge cell 104. Thus, hindrance to an image of the plasma display panel can be reduced.

Also in the seventh embodiment, an effect of reducing noise similar to that in the first embodiment can be achieved.

### Seventh Embodiment

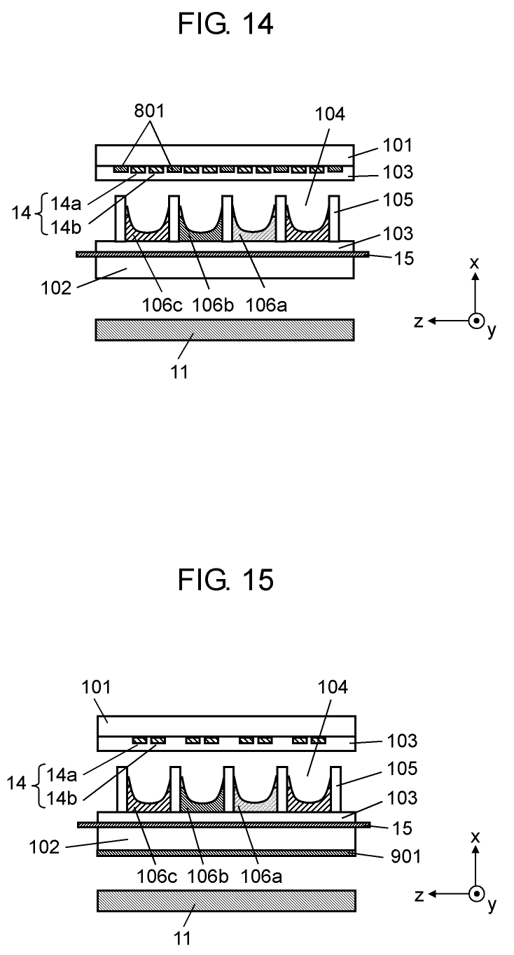

Next, a seventh embodiment is described with reference to FIG. 14. FIG. 14 is a sectional view showing plasma display panel 10 in accordance with the seventh embodiment. The same reference numerals are given to the same configuration as in the sixth embodiment and the detailed description thereof is omitted.

Conductor wiring portion 801 of this embodiment is different from conductor wiring portion 701 shown in FIG. 13B in the sixth embodiment in that conductor wiring portion 801 is formed on the surface opposite to the display surface of front glass plate 101.

That is to say, the first conductor portion includes conductor wiring portion 801 having a plurality of metal wirings provided at the display surface side of front glass plate 101 of plasma display panel 10, that is, on the surface of the side of back cover 16.

Furthermore, a plurality of conductor wirings arranged in parallel to scan-sustain electrodes 14 are disposed in a way in which they are located above the front surface of barrier ribs 105 seen from the side of a viewer, that is, the side opposite to back cover 16 so as not to block the side of the display surface of discharge cell 104. That is to say, the conductor wirings are disposed in a way in which they are located above barrier ribs 105 between discharge cells 104 of plasma display panels 10. As a result, the conductor wirings can be formed in the position that is more closer to barrier ribs 105 as compared with the sixth embodiment. Thus, they can be formed without substantially blocking the transmittance of image light emitted from discharge cell 104. Thus, hindrance to an image of the plasma display panel can be reduced.

With such a configuration, at the same time when scan-sustain electrodes 14 are formed, conductor wiring portion 801 can be formed. Therefore, processes are not increased more than necessary, so that manufacturing can be simplified.

### Eighth Embodiment

Next, an eighth embodiment is described with reference to FIG. 15. FIG. 15 is a sectional view showing plasma display panel 10 in accordance with the eighth embodiment. The same reference numerals are given to the same configuration as in the seventh embodiment and the detailed description thereof is omitted.

Conductor wiring portion 901 of this embodiment is different from conductor wiring portion 701 of the sixth embodiment shown in FIG. 13B in that it is formed on rear glass plate 102 at the side facing the chassis conductor 11. Furthermore, at this time, conductor wiring portion 901 is formed on the surface at the rear surface side of rear glass plate 102 with respect to discharge cell 104. Therefore, since it is not necessary to consider the transmittance of image light emitted from discharge cell 104, conductor wiring portion 901 is not necessarily formed in a wiring shape. Therefore, conductor wiring portion 901 may be attached to the entire surface of rear glass plate 102. Note here that conductor wiring portion 901 is formed of a metal material such as copper.

As mentioned above, the first conductor portion of plasma display panel 10 in this embodiment includes conductor wiring portion 901 formed on the entire surface of glass plate 102 at the rear side of discharge cell 104.

Thus, since conductor wiring portion 901 can be formed of a metal material such as copper on the entire surface of rear glass plate 102, the resistivity of conductor wiring portion 901 can be reduced as compared with that of conductor wiring portion 701 in accordance with the seventh embodiment. Therefore, an induced current flows easily in conductor wiring portion 901, thus enabling a large cancelling effect to be achieved. Furthermore, since it is not necessary to make conductor wiring portion 901 in a wiring shape, manufacturing is simplified.

### Ninth Embodiment

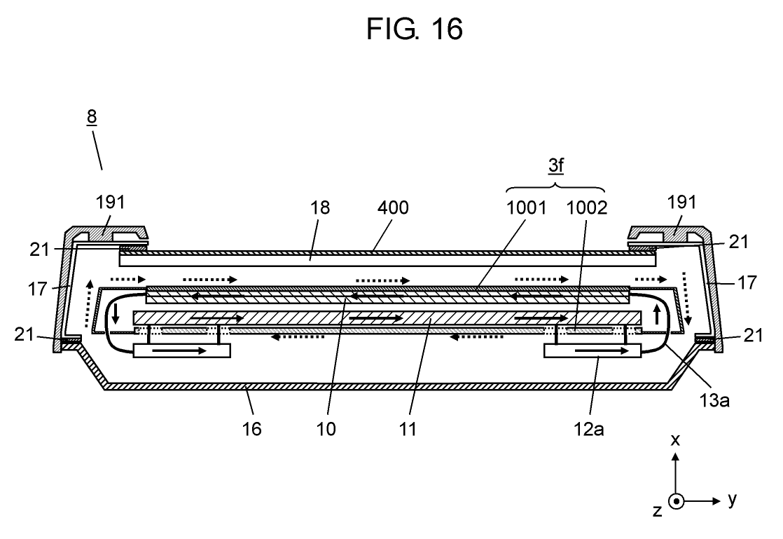

Next, a ninth embodiment of the present invention is described with reference to FIG. 16. The same reference numerals are given to the same configuration as in the sixth embodiment and the detailed description thereof is omitted. In the sixth embodiment, second conductor portion 702 is used similarly to second conductor portion 302 in the first embodiment. However, the ninth embodiment is different in that second conductor portion 1002 is used in cylindrical conductor portion 3f. Note here that conductor wiring portions 701 and 1001 may have the same configuration.

FIG. 16 is a schematic cross-sectional view to illustrate a configuration of plasma display device 8 in accordance with the ninth embodiment of the present invention.

As shown in FIG. 16, plasma display device 8 in this embodiment includes a conductor layer on chassis conductor 11 via an insulating layer. Grounds of various drive circuit boards are coupled to chassis conductor 11. Furthermore, the conductor layer is disposed on chassis conductor 11 at the side opposite to the plasma display panel. The conductor layer is coupled to first conductive filter 1001 as a first conductor portion so as to form second conductor portion 1002. That is to say, first conductive filter 1001 and the conductor layer form cylindrical conductor portion 3f.

Furthermore, second conductor portion 1002 has the same configuration as that of second conductor portion 502 in the fourth embodiment. That is to say, it has a plurality of openings in a part thereof. Flexible cable 13a is coupled to second conductor portion 1002 via the opening. Furthermore, grounds of various drive circuit boards are not brought into electrical contact with second conductor portion 1002 and coupled to chassis conductor 11.

With such a configuration, since second conductor portion 1002 is laminated on chassis conductor 11, it is possible to further reduce the thickness of plasma display device 8 as compared with the sixth embodiment.

Furthermore, preparation of disposing a conductor layer on chassis conductor 11 via an insulating layer can be carried out in advance. Therefore, assembly can be further simplified as compared with the sixth embodiment.

Also in this embodiment, similar to the first embodiment, an effect of cancelling a magnetic field can be achieved. As a result, a large effect of reducing noise can be achieved.

Furthermore, in this embodiment, second conductor portion 1002 is disposed on chassis conductor 11 via an insulating layer. Chassis conductor 11 and second conductor portion 1002 have a two-layered structure. Furthermore, grounds of various drive circuit boards are coupled to a conductor layer at the side facing the plasma display panel 10. However, plasma display device 8 in this embodiment is not necessarily limited to this configuration. That is to say, as shown in the other example of the fourth embodiment, second conductor portion 1002 may be disposed on chassis conductor 11 at the side facing the plasma display panel 10. Also with such a configuration, an effect of cancelling a magnetic field can be achieved.

As mentioned above, a conductor layer may be disposed on chassis conductor 11 via an insulating layer, and any one of chassis conductor 11 and the conductor layer may be coupled to grounds of various drive circuit boards as a circuit board and the other may be coupled to the first conductor portion so as to form a second conductor portion.

However, as in this embodiment, a configuration in which grounds of various drive circuit boards are coupled to the conductor layer at the side of plasma display panel 10 can provide a large effect of reducing noise since a loop of the driving current and a loop of cylindrical conductor portion 3f are interlinkaged to each other more widely.

### Tenth Embodiment

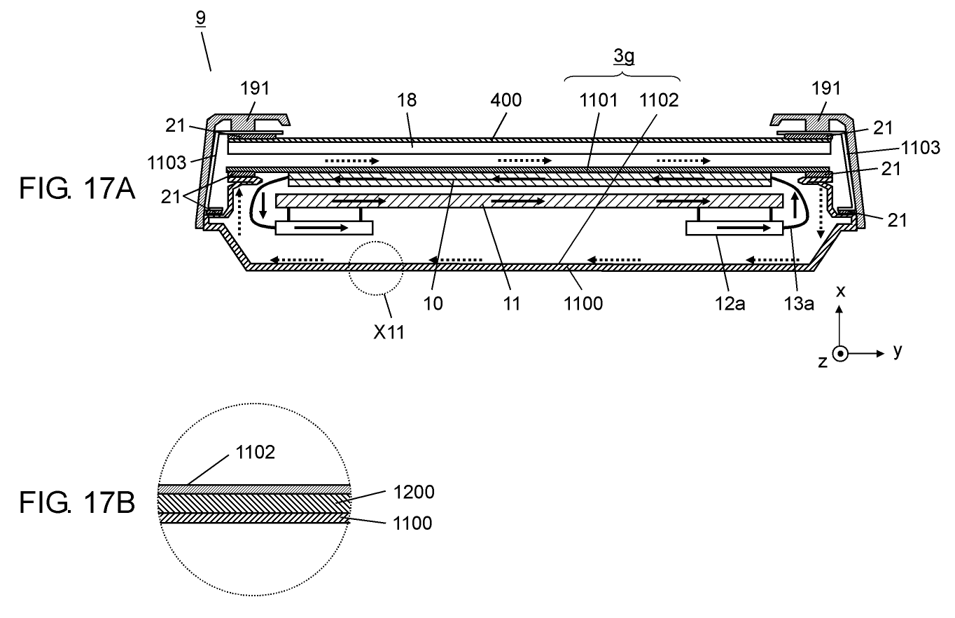

Next, plasma display device 9 in accordance with a tenth embodiment of the present invention is described with reference to FIGS. 17A and 17B. The same reference numerals are given to the same configuration as in the sixth and ninth embodiments and the detailed description thereof is omitted. In the sixth and ninth embodiments, conductor wiring portions 601 and 701 are used as the first conductor portion, respectively. However, the tenth embodiment is different in that second conductor portion 1102 formed on back cover 1100 is used so as to form cylindrical conductor portion 3g as in the fifth embodiment. Note here that conductor wiring portions 701, 1001 and 1101 may have the same configuration.

FIG. 17A is a schematic cross-sectional view to illustrate a configuration of plasma display device 9 in accordance with the tenth embodiment of the present invention. FIG. 17B is an expanded view showing region X11 by expanding thereof.

As shown in FIG. 17B, in back cover 1100 functioning as a conductive case, second conductor portion 1102 of cylindrical conductor portion 3g is formed on the inner side of conductive back cover 1100 via insulating layer 1200 by conductive plating. Furthermore, as shown in FIG. 17A, back cover 1100 is electrically coupled to glass pressing metal 1103 at the outer side surface via conductive gasket 21. Furthermore, second conductor portion 1102, which is formed on the inner side by plating, of back cover 1100 is brought into electrical contact with conductor wiring portion 1101 via conductive gasket 21.

At this time, the inside and outside of back cover 1100 are electrically insulated from each other, and cylindrical conductor portion 3g is not electrically connected to back cover 1100 or glass pressing metal 1103, which functions as a short ring function.

As mentioned above, plasma display device 9 in this embodiment has back cover 1100 as a conductive case at the opposite side to a viewer of plasma display module 2. An insulating layer is formed at the inside of the conductive case. Second conductor portion 1102 is formed on an insulating layer of the conductive case by conductive plating.

With such a configuration, since second conductor portion 1102 is formed on the inner side of back cover 1100 by plating, a separate second conductor portion as in the sixth to ninth embodiments is not needed. Furthermore, since a two-layered structure chassis conductor 11 as in the ninth embodiment is not also needed, the thickness of plasma display device 9 can be further reduced.

Furthermore, since preparation of subjecting back cover 1100 to insulation treatment and plating treatment can be carried out in advance, assembly can be simplified as compared with seventh to tenth embodiments.

Note here that the formation of second conductor portion 1102 is not necessarily limited to plating. For example, the formation may be carried out by attaching with the use of, for example, a metal tape.

Furthermore, plasma display device 9 in accordance with this embodiment is brought into electrical contact with conductor wiring portion 1101 via conductive gasket 21. Conductor wiring portion 1101 has a metal wiring thin wires similar to conductor wiring portion 701 as described in the sixth embodiment.

With such a configuration, also in this embodiment, a large effect of reducing noise similar to the first embodiment can be achieved.

Furthermore, any embodiments employ a configuration of cylindrical conductor in which a driving current loop at the time of sustain discharge is cancelled. However, the configuration is not limited to this alone. For example, at the time of address discharge, a current loop flowing in the longitudinal direction (for example, the x-z plane in FIG. 2) is formed. Therefore, by configuring a cylindrical conductor in accordance with this, it is possible to reduce an interfering electromagnetic wave generated at the time of address discharge.

Specific numeric values and the like used in the above-mentioned embodiments are just examples and can be set appropriately and suitably in accordance with the properties of display devices, specification of image display devices, and the like.

The above-mentioned embodiments are just a few of many possible examples. The present invention is not limited to the above-mentioned embodiments and various modifications are encompassed within the scope of the appended claims.

What is claimed is:

1. A plasma display device comprising:
a plasma display module including:
a plasma display panel having a front glass plate and a rear glass plate provided with a plurality of electrodes that are parallel to each other and having a plurality of discharge cells divided by barrier ribs;
a circuit board for applying a voltage to the electrodes; and
a chassis conductor configured to hold the plasma display panel, the chassis conductor being coupled to a ground of the circuit board; and
a cylindrical conductor configured to surround the plasma display module, the cylindrical conductor including a first conductor portion located at a front surface side of the plasma display module and a second conductor portion located at a pair of side surfaces facing each other and at a rear surface of the plasma display module,
wherein a loop formed by the cylindrical conductor is substantially in parallel to a loop formed by a current flowing in the circuit board, the electrodes and the chassis conductor in the plasma display module.

2. The plasma display device of claim 1,
wherein the first conductor portion is configured to face an image display surface of the plasma display panel, and includes a first conductive filter having a light transmission property and having a substantially rectangular-shaped surface.

3. The plasma display device of claim 2,
wherein the first conductive filter includes a base material and a plurality of metal thin wires provided on the base material in parallel to the electrodes.

4. The plasma display device of claim 3,
wherein the metal thin wires are located above front surfaces of the barrier ribs viewed from a side opposite to a back cover, and above the barrier ribs between the discharge cells of the plasma display panel.

5. The plasma display device of claim 2, further comprising:
a front protective glass provided at a side opposite to a back cover of the plasma display module,
wherein a second conductive filter is provided on a surface at a side opposite to the back cover of the front glass, and the first conductive filter is provided on a surface of the front glass facing the plasma display panel.

6. The plasma display device of claim 1,
wherein the first conductor portion is formed on a surface of the plasma display panel facing the front protective glass and is made of a conductor wiring portion including a plurality of conductors arranged in parallel to the electrodes and between discharge cells.

7. The plasma display device of claim 6,
wherein the plurality of conductors are a plurality of metal wirings located above front surfaces of the barrier ribs viewed from a side opposite to the back cover, and above the barrier ribs between the discharge cells of the plasma display panel.

8. The plasma display device of claim 1, further comprising:
a conductor layer disposed on the chassis conductor via an insulating layer,
wherein one of the chassis conductor or the conductor layer is coupled to a ground of the circuit board, and the other is coupled to the first conductor portion so as to form the second conductor portion.

9. The plasma display device of claim 8,
wherein the conductor layer is disposed on the chassis conductor at a side opposite to the plasma display panel,
a ground of the circuit board is coupled to the chassis conductor, and the conductor layer is coupled to the first conductor portion so as to form the second conductor portion.

10. The plasma display device of claim 1, further comprising:
a conductive case at a side opposite to a display surface of the plasma display module,
wherein an insulating layer is formed on an inner side of the conductive case, the second conductor portion is formed on the insulating layer of the conductive case by conductive plating.

11. The plasma display device of claim 1,
wherein the plurality of electrodes are scan-sustain electrodes.

12. The plasma display device of claim 1,
wherein the first conductor portion includes a conductor wiring portion formed on an entire surface of the rear glass plate at the rear side of the discharge cell.

13. A plasma display device comprising:
a plasma display module including:
a plasma display panel having a front glass plate and a rear glass plate provided with a plurality of electrodes that are parallel to each other and having a plurality of discharge cells divided by barrier ribs;
a circuit board for applying a voltage to the electrodes; and
a chassis conductor configured to hold the plasma display panel, the chassis conductor being coupled to a ground of the circuit board; and
a conductor provided to loop around the plasma display module, wherein the loop formed by the conductor is substantially in parallel to a loop formed by a current flowing in the circuit board, the electrodes and the chassis conductor in the plasma display module.

14. The plasma display device of claim 13, wherein the conductor is provided to loop around the plasma display module in a longitudinal x-y plane.

15. The plasma display panel of claim 14, wherein the conductor includes conductive portions located at a front surface side of the plasma display module, at a pair of side surfaces of the plasma display module and at a rear surface of the plasma display module.

16. A plasma display device comprising:
a plasma display module including:
a plasma display panel having a front glass plate and a rear glass plate provided with a plurality of electrodes that are parallel to each other and having a plurality of discharge cells divided by barrier ribs;
a circuit board for applying a voltage to the electrodes; and
a chassis conductor configured to hold the plasma display panel, the chassis conductor being coupled to a ground of the circuit board; and
a conductor provided to loop around the plasma display module, wherein the loop formed by the conductor is configured to generate an induced current which flows in an opposite direction to current flowing in the circuit board, the electrodes and the chassis conductor in the plasma display module.

17. The plasma display device of claim 16, wherein a magnetic field generated by the induced current of the conductor substantially cancels out a magnetic field generated by the current flowing in the circuit board, the electrodes and the chassis conductor.
